(19) United States
(12) Patent Application Publication
(10) Pub. No.: US 2010/0119262 A1
(43) Pub. Date: May 13, 2010

(54) LIGHT SOURCE DEVICE, OPTICAL SCANNING DEVICE, AND IMAGE FORMING APPARATUS

(75) Inventors: Atsufumi Omori, Kanagawa (JP); Yasuhiro Nihei, Kanagawa (JP); Jun Tanabe, Kanagawa (JP)

Correspondence Address: COOPER & DUNHAM, LLP, 30 Rockefeller Plaza, 20th Floor, NEW YORK, NY, 10112, US

(73) Assignee: RICOH COMPANY, LTD., Tokyo (JP)

(21) Appl. No.: 12/609,087

(22) Filed: Oct. 30, 2009

(30) Foreign Application Priority Data
Nov. 13, 2008 (JP) 2008-290874

(51) Int. Cl. G03G 15/04; H01J 7/24

(52) U.S. Cl. 399/220; 315/112

(57) ABSTRACT

A light source device includes a light source that includes a plurality of light emitting units, a drive circuit that drives the light source, and a circuit board on which the light source is mounted in a first area and the drive circuit is mounted in a second area and which includes a radiation mechanism between the first area and the second area for heat from the drive circuit.

### CROSS-REFERENCE TO RELATED APPLICATIONS

The present application claims priority to and incorporates by reference the entire contents of Japanese Patent Application No. 2008-290874 filed in Japan on Nov. 13, 2008.

### BACKGROUND OF THE INVENTION

1. Field of the Invention

The present invention relates to a light source device, an optical scanning device, and an image forming apparatus.

2. Description of the Related Art

In recent years, in a field of an image forming apparatus such as a laser printer and a digital copier, a demand is growing for improving an image forming speed (high speed) and writing density (high density). To meet the demand, a method is proposed, for example, in Japanese Patent Application Laid-open No. 2003-283031 to scan a scanning surface with a plurality of light beams by using an optical scanning device that includes a light source including a plurality of light emitting sources.

However, in a high-speed and high-density image forming apparatus, heat generated in a drive circuit that supplies a drive signal to a light source tends to increase. The drive circuit is typically provided near the light source for suppressing delay of the drive signal. Heat generated in the drive circuit may shorten the lifetime of the light source and lower the image quality. Therefore, various methods of radiating heat have been proposed as a countermeasure, such as one disclosed in Japanese Patent Application Laid-open No. 2005-74978.

However, an optical scanning device disclosed in Japanese Patent Application Laid-open No. 2005-74978 needs a radiation fin, an air duct, and an exhaust fan, which leads to increase in size and cost of the device.

### SUMMARY OF THE INVENTION

It is an object of the present invention to at least partially solve the problems in the conventional technology.

According to an aspect of the present invention there is provided a light source device including a light source that includes a plurality of light emitting units; a drive circuit that drives the light source; and a circuit board on which the light source is mounted in a first area and the drive circuit is mounted in a second area and which includes a radiation mechanism between the first area and the second area for heat from the drive circuit.

According to another aspect of the present invention there is provided an optical scanning device that scans a scanning surface with a light beam, the optical scanning device including a light source device including a light source that includes a plurality of light emitting units, a drive circuit that drives the light source, and a circuit board on which the light source is mounted in a first area and the drive circuit is mounted in a second area and which includes a radiation mechanism between the first area and the second area for heat from the drive circuit, a deflector that deflects the light beam output from the light source device; and a scanning optical system that focuses the light beam deflected by the deflector on the scanning surface.

According to still another aspect of the present invention there is provided an image forming apparatus including at least one image carrier; and at least one optical scanning device that scans the image carrier with a light beam containing image information and that includes a light source device including a light source that includes a plurality of light emitting units, a drive circuit that drives the light source, and a circuit board on which the light source is mounted in a first area and the drive circuit is mounted in a second area and which includes a radiation mechanism between the first area and the second area for heat from the drive circuit, a deflector that deflects the light beam output from the light source device, and a scanning optical system that focuses the light beam deflected by the deflector on the scanning surface.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a configuration of a laser printer according to a present embodiment of the present invention;

FIG. 2 is a schematic diagram of an optical scanning device as shown in FIG. 1;

FIG. 3 is a schematic diagram for explaining light emitting units of a light source;

FIG. 4 is a schematic diagram for explaining a light source package;

FIG. 5 is a block diagram for explaining a configuration of a drive control device;

FIG. 6 is a schematic diagram for explaining a driving package;

FIG. 7 is a schematic diagram for explaining a mounting state of the light source package and the driving package on a control board;

FIG. 8 is another schematic diagram for explaining a mounting state of the light source package and the driving package on the control board;

FIG. 9 is a cross sectional view taken along line A-A in FIG. 7;

FIG. 10 is a schematic diagram for explaining an arrangement of radiation fins shown in FIG. 7;

FIG. 11 is a schematic diagram for explaining a radiation fan;

FIG. 12 is a schematic diagram for explaining an arrangement position of the radiation fan;

FIG. 13 is a schematic diagram for explaining a first modification example of a light source device;

FIG. 14 is a schematic diagram for explaining a second modification example of the light source device;

FIG. 15 is a schematic diagram for explaining a third modification example of the light source device;

FIG. 16 is a schematic diagram for explaining a fourth modification example of the light source device;

FIG. 17 is a schematic diagram for explaining a fifth modification example of the light source device;

FIG. 18 is a schematic diagram for explaining a sixth modification example of the light source device;

FIG. 19 is a schematic diagram for explaining a seventh modification example of the light source device;

FIG. 20 is another schematic diagram for explaining the seventh modification example of the light source device;

FIG. 21 is a cross sectional view taken along line A-A in FIG. 19;

FIG. 22 is a schematic diagram for explaining a radiation fan in the seventh modification example;

FIG. 23 is a schematic diagram for explaining an eighth modification example of the light source device;

FIG. 24 is another schematic diagram for explaining the eighth modification example of the light source device;

FIG. 25 is a cross sectional view taken along line A-A in FIG. 23;

FIG. 26 is a schematic diagram for explaining a radiation fan in the eighth modification example; and

FIG. 27 is a schematic diagram illustrating a configuration of a color printer.

### DETAILED DESCRIPTION OF THE PREFERRED EMBODIMENTS

Exemplary embodiments of the present invention are explained in detail below with reference to the accompanying drawings.

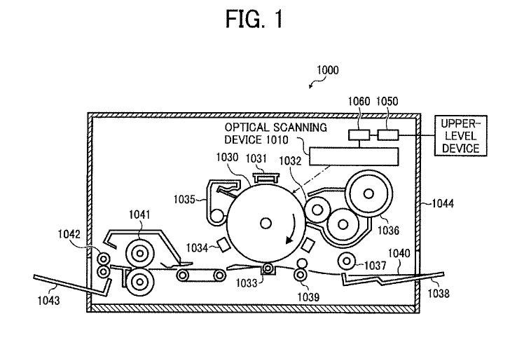

FIG. 1 is a schematic diagram illustrating a configuration of a laser printer 1000 as an image forming apparatus according to a present embodiment of the present invention. The laser printer 1000 includes an optical scanning device 1010, a photosensitive element 1030, a charging unit 1031, a developing roller 1032, a transfer charging unit 1033, a neutralizing unit 1034, a cleaning unit 1035, a toner cartridge 1036, a feeding roller 1037, a feed tray 1038, a pair of registration rollers 1039, a fixing roller 1041, a discharging roller 1042, a discharge tray 1043, a communication control device 1050, and a printer control device 1060 that collectively controls the above units. The above units are accommodated at predetermined positions in a printer housing 1044.

The communication control device 1050 controls a bilateral communication with an upper-level device, such as a personal computer (PC), via a network or the like.

The photosensitive element 1030 having a cylindrical shape has a photosensitive layer on its surface. The photosensitive layer functions as a scanning surface. The photosensitive element 1030 rotates in a direction indicated by an arrow in FIG. 1.

The charging unit 1031, the developing roller 1032, the transfer charging unit 1033, the neutralizing unit 1034, and the cleaning unit 1035 are arranged around the photosensitive element 1030 in this order along a direction in which the photosensitive element 1030 rotates.

The charging unit 1031 uniformly charges the surface of the photosensitive element 1030.

The optical scanning device 1010 irradiates the surface of the photosensitive element 1030 charged by the charging unit 1031 with a light beam that is modulated based on image information from the upper-level device. Consequently, a latent image corresponding to the image information is formed on the surface of the photosensitive element 1030. The latent image moves along with the rotation of the photosensitive element 1030 in a direction toward the developing roller 1032.

Toner is accommodated in the toner cartridge 1036 and is supplied to the developing roller 1032.

The developing roller 1032 develops the latent image by causing the toner supplied from the toner cartridge 1036 to adhere to the latent image on the surface of the photosensitive element 1030 to obtain a visible image based on the image information. The latent image (hereinafter, “toner image” for convenience in some cases) to which the toner is adhered moves in a direction toward the transfer charging unit 1033 along with the rotation of the photosensitive element 1030.

Recording sheets 1040 are accommodated in the feed tray 1038. The feeding roller 1037, which is arranged near the feed tray 1038, picks up the recording sheets 1040 one by one from the feed tray 1038 to convey it to the registration rollers 1039. The registration rollers 1039 once hold the recording sheet 1040 picked up by the feeding roller 1037 and conveys it toward a nip formed between the photosensitive element 1030 and the transfer charging unit 1033 in synchronization with the rotation of the photosensitive element 1030.

The transfer charging unit 1033 is applied with a voltage having a polarity opposite to that of the toner to electrically attract the toner on the surface of the photosensitive element 1030 to the recording sheet 1040. With this voltage, the toner image on the surface of the photosensitive element 1030 is transferred onto the recording sheet 1040. The recording sheet 1040 with the toner image transferred thereon is conveyed to the fixing roller 1041.

The recording sheet 1040 is applied with heat and pressure by the fixing roller 1041, so that the toner image on the recording sheet 1040 is fixed thereto. Then, the recording sheet 1040 with the toner image fixed thereto is conveyed to the discharge tray 1043 by the discharging roller 1042 to be stacked thereon in order.

The neutralizing unit 1034 neutralizes the surface of the photosensitive element 1030.

The cleaning unit 1035 removes toner (residual toner) remaining on the surface of the photosensitive element 1030. The surface of the photosensitive element 1030 from which the residual toner is removed returns to a position opposing the charging unit 1031 again.

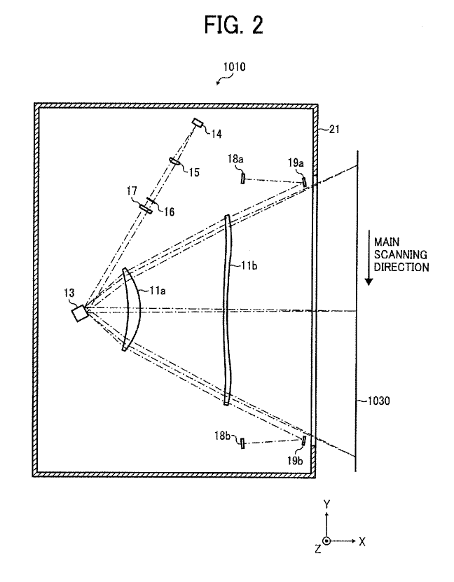

The configuration of the optical scanning device 1010 is explained. As shown in FIG. 2, the optical scanning device 1010 includes a light source device 14, a coupling lens 15, an aperture plate 16, a cylindrical lens 17, a polygon mirror 13, a deflector-side scanning lens 11a, an image-plane-side scanning lens 11b, g light detecting sensors 18a and 18b, and light detecting mirrors 19a and 19b. The above units are arranged at predetermined positions in a housing 21.

In the specification, in an XYZ three-dimensional Cartesian coordinate system, a Y-axis direction is a direction along a longitudinal direction of the photosensitive element 1030, and an X-axis direction is a direction along an optical axis of the scanning lenses 11a and 11b. Moreover, in the following explanation, a direction corresponding to the main-scanning direction is indicated as a main-scanning corresponding direction, and a direction corresponding to the sub-scanning direction is indicated as a sub-scanning corresponding direction, for convenience.

The light source device 14 includes a light source 100 that includes a plurality of light emitting units and a drive control device 22 that drives the light source 100.

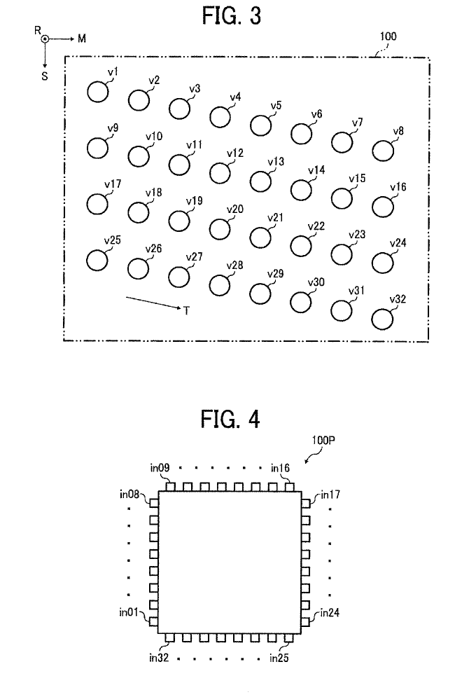

As shown in FIG. 3 as an example, the light source 100 is a two-dimensional array that is formed by two-dimensionally arranging 32 light emitting units v1 to v32 on one substrate. In FIG. 3, an M direction corresponds to the main-scanning corresponding direction and an S direction corresponds to the sub-scanning corresponding direction that is the same as a Z-axis direction. Furthermore, a T direction is a direction that is inclined from the M direction toward the S direction, and an R direction is a direction in which a light beam is emitted from each of the light emitting units v1 to v32.

The light source 100 includes four rows of light emitting units, in each of which eight light emitting units are arranged at equal intervals along the T direction. The four rows of light emitting units are arranged so that when all of the light emitting units v1 to v32 are orthographically projected on a virtual line extending in the S direction, an interval therebetween is the same. In the specification, the term “a light-emitting-unit interval” denotes an interval between the centers of two adjacent light emitting units.

Each of the light emitting units v1 to v32 is a vertical cavity surface emitting laser (VCSEL) of which oscillation wavelength is 780 nanometer (nm) band. In other words, the light source 100 is a so-called VCSEL array including 32 light emitting units.

As shown in FIG. 4 as an example, the light source 100 is accommodated in a package 100P of a quad flat package (QFP) type. Terminals in01 to in32 in FIG. 4 correspond to the light emitting units v1 to v32, respectively, and are input terminals to which the respective drive signals are input. Hereinafter, the package 100P in which the light source 100 is accommodated is also referred to as “light source package 100P” as a matter of convenience.

The coupling lens 15 shown in FIG. 2 collimates a light beam emitted from the light source device 14 into an approximately parallel light beam.

An aperture is formed in the aperture plate 16, which defines a diameter of the light beam reached thereto via the coupling lens 15.

The cylindrical lens 17 focuses the light beam that has passed through the aperture of the aperture plate 16 near a deflection/reflection surface of the polygon mirror 13 with respect to the sub-scanning corresponding direction (the Z-axis direction).

An optical system arranged on the optical path between the light source device 14 and the polygon mirror 13 is also called a pre-deflector optical system. In the present embodiment, the pre-deflector optical system includes the coupling lens 15, the aperture plate 16, and the cylindrical lens 17.

The polygon mirror 13 has four mirror surfaces each of which functions as the deflection/reflection surface. The polygon mirror 13 rotates at a constant angular rate around an axis parallel to the Z-axis direction to deflect the light beam from the cylindrical lens 17.

The deflector-side scanning lens lie is arranged on an optical path of a light beam deflected by the polygon mirror 13.

The image-plane-side scanning lens 11b is arranged on an optical path of a light beam that has passed through the deflector-side scanning lens 11a. The light beam that has passed through the image-plane-side scanning lens 11b is irradiated to the surface of the photosensitive element 1030 to form a light spot. The light spot moves in the longitudinal direction of the photosensitive element 1030 along with the rotation of the polygon mirror 13. In other words, the light spot scans the surface of the photosensitive element 1030. At this time, the moving direction of the light spot corresponds to the main-scanning direction, and the rotation direction of the photosensitive element 1030 corresponds to the sub-scanning direction.

An optical system arranged between the polygon mirror 13 and the photosensitive element 1030 is also called a scanning optical system. In the present embodiment, the scanning optical system includes the deflector-side scanning lens 11a and the image-plane-side scanning lens 11b. At least one reflecting mirror can be arranged on at least one of optical paths between the deflector-side scanning lens 11a and the image-plane-side scanning lens 11b and between the image-plane-side scanning lens 11b and the photosensitive element 1030.

Part of light beams before writing enters the light detecting sensor 18a via the light detecting mirror 19a from among light beams that are deflected by the polygon mirror 13 and pass the scanning optical system. Part of light beams after writing enters the light detecting sensor 18b via the light detecting mirror 19b from among the light beams that are deflected by the polygon mirror 13 and pass the scanning optical system.

Each of the light detecting sensors 18a and 18b generates an electrical signal (photoelectric conversion signal) corresponding to light intensity of the received light, and outputs the signal to the drive control device 22.

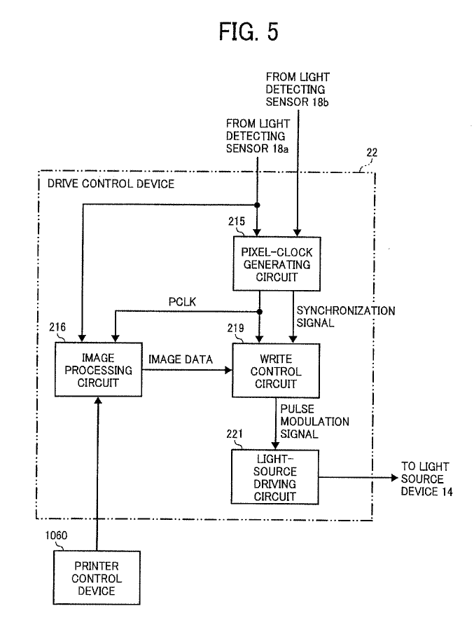

As shown in FIG. 5 as an example, the drive control device 22 includes a pixel-clock generating circuit 215, an image processing circuit 216, a write control circuit 219, and a light-source driving circuit 221. Arrows in FIG. 5 indicate flows of representative signals and information and thus do not indicate all connection relations between the blocks.

The pixel-clock generating circuit 215 determines time required for a light beam to scan between the light detecting sensors 18a and 18b based on signals output from the light detecting sensors 18a and 18b, sets the frequency so that the preset number of pulses is contained in the determined time, and generates a pixel clock signal PCLK having the set frequency. The generated pixel clock signal PCLK is supplied to the image processing circuit 216 and the write control circuit 219. The signal output from the light detecting sensor 18a is output to the write control circuit 219 as a synchronization signal.

The image processing circuit 216 rasterizes the image information received from the upper-level device via the communication control device 1050 and the printer control device 1060 and generates image data representing gradation of each pixel with the pixel clock signal PCLK as a reference for each light emitting unit after performing a predetermined halftone process and the like. Then, when the image processing circuit 216 detects a scan start based on the signal output from the light detecting sensor 18a, the image processing circuit 216 outputs image data to the write control circuit 219 in synchronization with the pixel clock signal PCLK.

The write control circuit 219 generates a pulse modulation signal based on the image data from the image processing circuit 216 and the pixel clock signal PCLK and the synchronization signal from the pixel-clock generating circuit 215.

The light-source driving circuit 221 drives each of the light emitting units v1 to v32 based on the pulse modulation signal from the write control circuit 219.

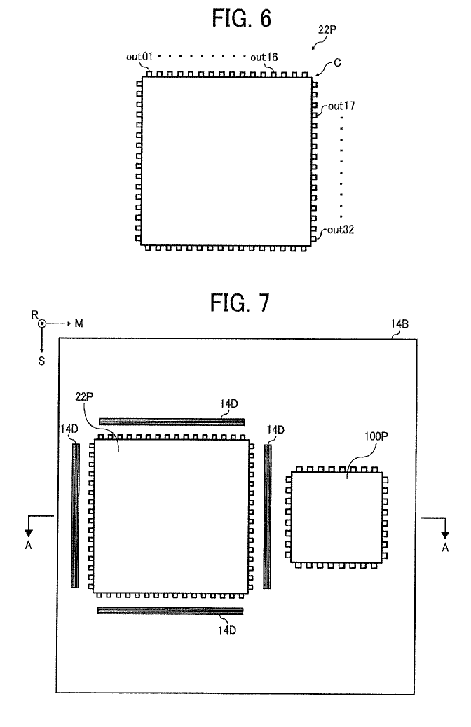

The drive control device 22 is stored in a QFP type package 22P as shown in FIG. 6 as an example. Therefore, the pixel-clock generating circuit 215, the image processing circuit 216, the write control circuit 219, and the light-source driving circuit 221 are arranged close to each other. Because these circuits are arranged close to each other, a high-frequency clock, various signals, and the like can be transmitted between the circuits with good quality, thereby enabling to accomplish high-speed and high-density image formation. The terminals out01 to out32 in FIG. 6, corresponding to the light emitting units v1 to v32, are output terminals through which the respective drive signals are output. Hereinafter, the package 22P in which the drive control device 22 is stored is also referred to as the drive package 22P″ as a matter of convenience. Terminals out01 to out32 are arranged near the two sides that form a corner portion C of the drive package 22P.

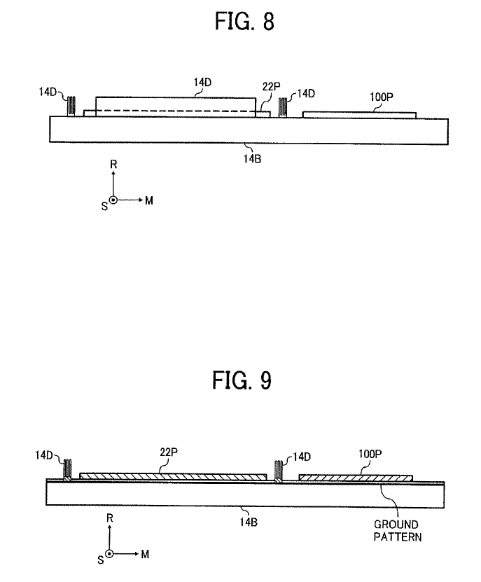

As shown in FIGS. 7 and 8 as an example, the light source package 100P and the drive package 22P are both mounted on the +R side of a control board 14B, apart from each other on one area and another area.

Four radiation fins 14D are provided around the drive package 22P on the control board 14B.

As shown in FIG. 9, each of the radiation fins 14D is in contact with a ground pattern of the control board 14B at its end on the -R side. Moreover, each of the radiation fins 14D has a shape in which a side in one direction is longer than a side in the other direction.

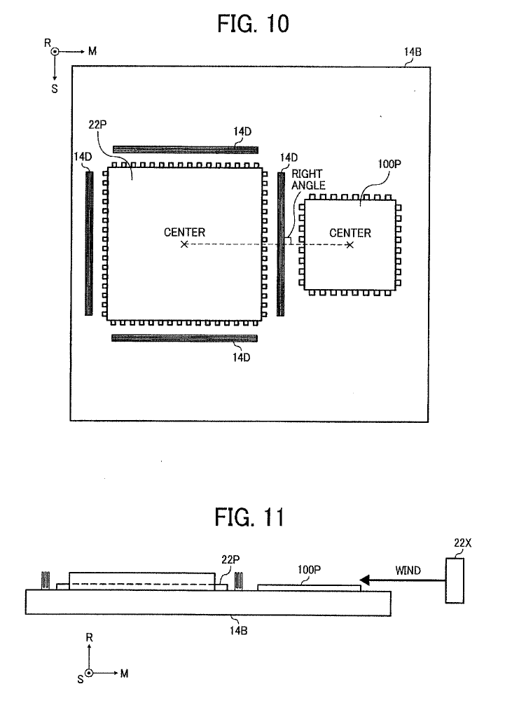

As shown in FIG. 10, the radiation fin 14D provided between the drive package 22P and the light source package 100P is arranged so that a longitudinal direction thereof is orthogonal to a virtual line connecting the centers of the drive package 22P and the light source package 100P.

Moreover, as shown in FIG. 11 as an example, a radiation fan 22X that sends the wind blowing in a direction from the side of the light source package 100P to the side of the drive package 22P is provided.

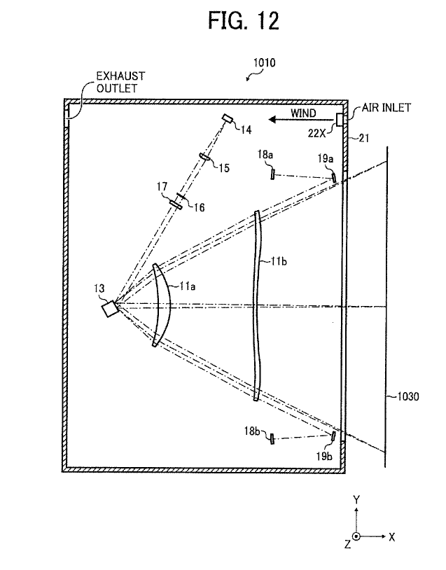

The radiation fan 22X is attached to the housing 21 as shown in FIG. 12 as an example.

As is apparent from the above explanation, the light source device 14 is such that the drive circuit is composed of the drive control device 22 and the circuit board is composed of the control board 14B.

As explained above, in the light source device 14 in the present embodiment, the light source 100 including a plurality of light emitting units is accommodated in the light source package 100P to be mounted on the control board 14B. Moreover, the drive control device 22 that drives the light source 100 is accommodated in the drive package 22P to be mounted on the control board 14B. Furthermore, four pieces of the radiation fins 14D are arranged around the drive package 22P.

In this case, increase in temperature of the drive package 22P can be suppressed and transfer of heat from the drive package 22P to the light source package 100P can be suppressed compared with the conventional technology. Therefore, increase in temperature of the light source 100 can be suppressed without increasing the size and cost.

Moreover, because each of the radiation fins 14D is in contact with the ground pattern of the control board 14B at its end on the -R side, an amount of heat that is conducted from the drive package 220 to the light source package 100P via the ground pattern can be reduced.

Furthermore, because the longitudinal direction of the radiation fin 14D provided between the drive package 22P and the light source package 1000 is orthogonal to a virtual line connecting the centers of the drive package 22P and the light source package 100P, heat from the drive package 22P can be suppressed from conducting to the light source package 100P in the shortest distance.

Moreover, because the radiation fan 22X that sends the wind blowing in a direction from the side of the light source package 100P to the side of the drive package 22P is provided, heat radiated from the radiation fins 14D can be suppressed from transferring to the side of the light source package 100P.

According to the present embodiment, because the optical scanning device 1010 includes the light source device 14, the optical scanning device 1010 can perform optical scanning stably without increasing the size and cost.

Moreover, according to the present embodiment, because the laser printer 1000 includes the optical scanning device 1010, the laser printer 1000 can form a high-quality image at high speed without increasing the size and cost.

In the present embodiment, if the amount of heat generated in the drive package 22P is not so large, the radiation fan 22X can be omitted.

Moreover, in the present embodiment, the four radiation fins 14D have approximately the same length; however, it is not limited thereto. For example, the radiation fin 14D arranged between the drive package 22P and the light source package 100P can be longer than the other radiation fins 14D.

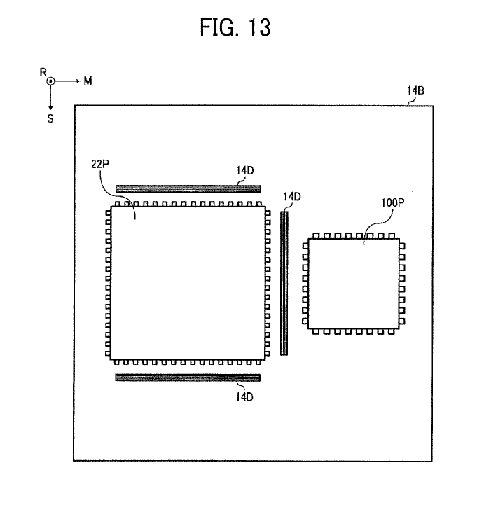

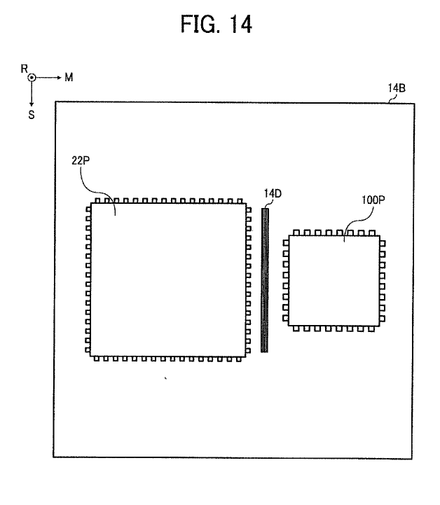

Furthermore, in the present embodiment, the four radiation fins 14D are provided around the drive package 22P. However, if the amount of heat generated in the drive package 22P is not so large, the number of the radiation fins 14D can be three or less. For example, FIG. 13 shows a case in which three radiation fins 14D are provided, and FIG. 14 shows a case in which one radiation fin 14D is provided.

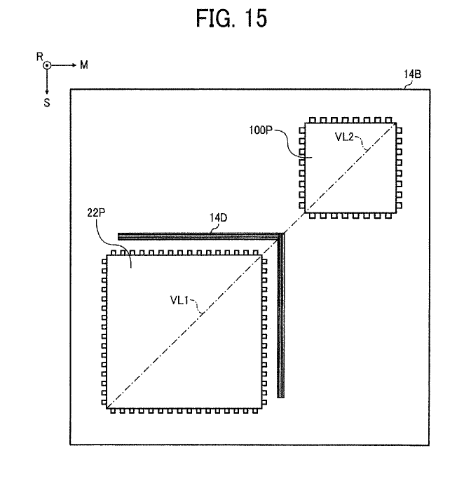

Moreover, in the present embodiment, the drive package 22P and the light source package 100P are arranged along the M direction; however, it is not limited thereto. For example, as shown in FIG. 15, the drive package 22P and the light source package 100P can be arranged such that a virtual line extending a diagonal line VL1 of the drive package 22P passing the corner portion C is approximately aligned with a virtual line extending a diagonal line VL2 of the light source package 100P.

In this case, the L-shaped radiation fin 14D can be provided between the drive package 222 and the light source package 1002, which can have the same effect as the radiation fin 14D in the present embodiment.

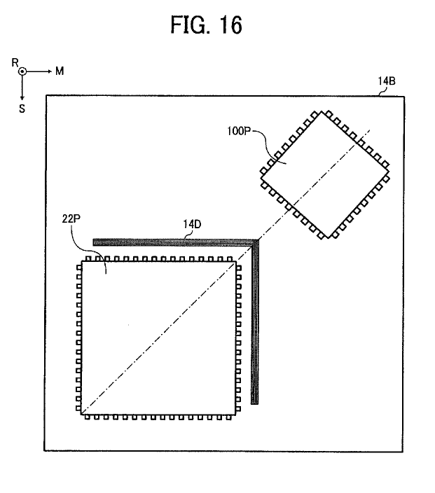

Moreover, as shown in FIG. 16, each side of the light source package 100P can be arranged to be in parallel with or orthogonal to a virtual line extending a diagonal line of the drive package 22P passing one corner portion and the light source package 100P can be divided approximately into two by the virtual line when viewed in the R direction. Even in this case, the same effect as that in the present embodiment can be achieved.

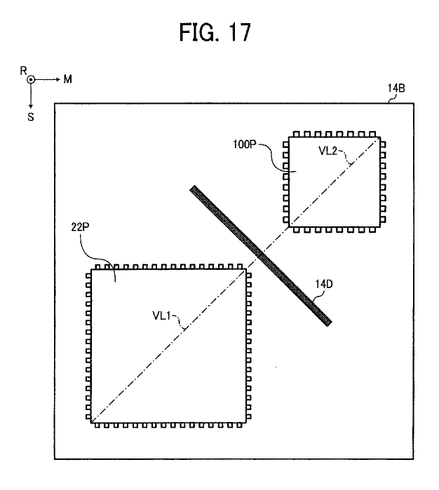

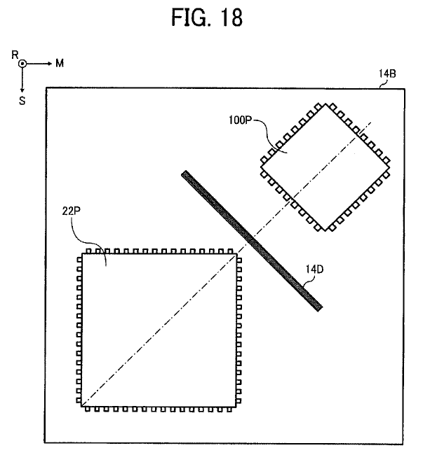

Furthermore, instead of the L-shaped radiation fin 14D, the radiation fin 14D having the same shape as that in the present embodiment can be arranged so that the longitudinal direction thereof is orthogonal to a virtual line connecting the centers of the drive package 22P and the light source package 1002 as shown in FIGS. 17 and 18.

Moreover, in the present embodiment, the light source package 1002 and the drive package 22P are mounted on the same side of the control board 14B; however, the light source package 100P and the drive package 22P can be mounted on different sides of the control board 14B.

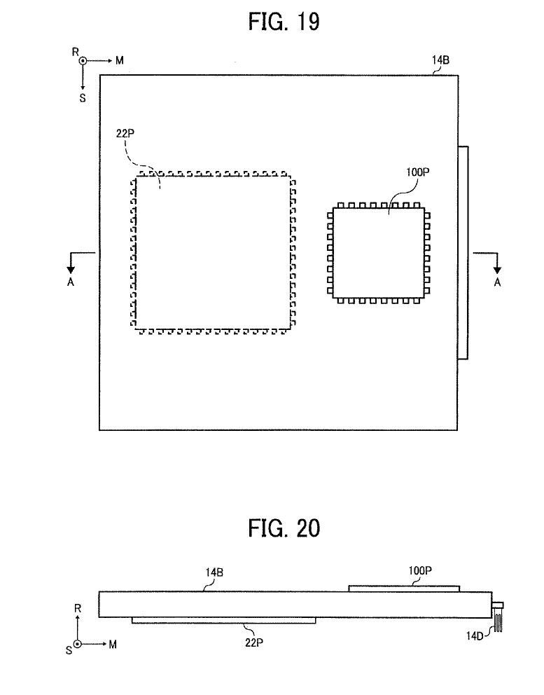

For example, as shown in FIGS. 19 and 20, the light source package 100P can be mounted on the surface of the +R side and the drive package 22P can be mounted on the surface of the −R side of the control board 14B, apart from each other on one area and another area.

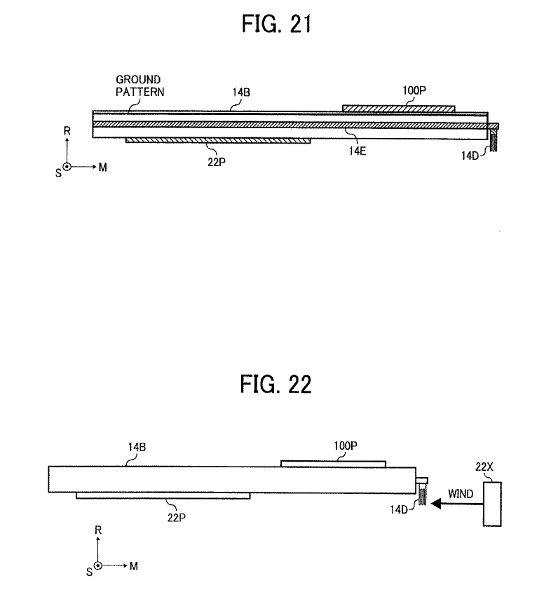

In this case, as shown in FIG. 21 as an example, a metal plate 14E can be inserted into the control board 14B to be parallel to the surface of the control board 14B. Consequently, heat of the drive package 22P can be suppressed from conducting to the light source package 100P. Moreover, the radiation fin 14D can be provided to the end of the metal plate 14E.

In this case, as shown in FIG. 22 as an example, the radiation fan 22X that sends the wind blowing in a direction from the side of the light source package 100P to the side of the drive package 22P when viewed in the R direction can be provided.

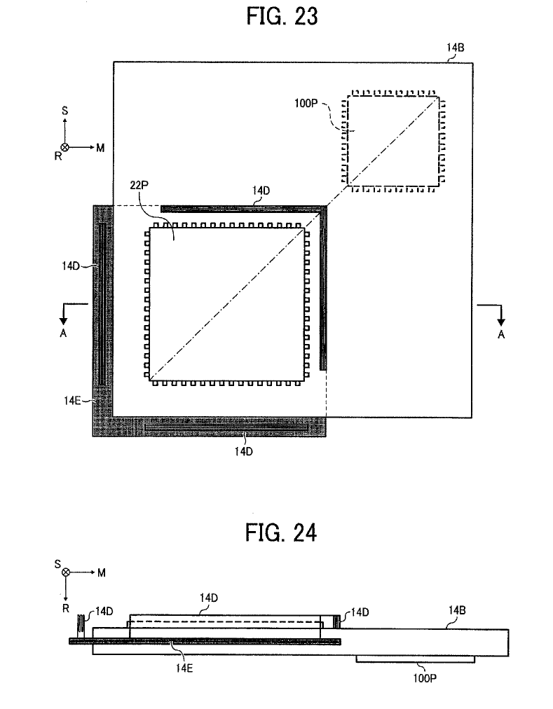

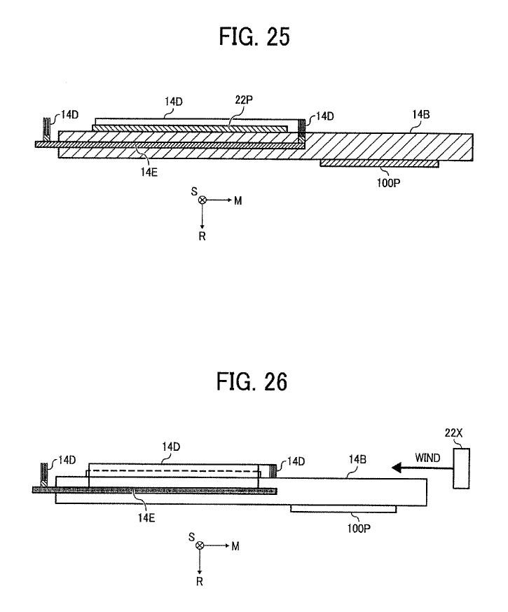

Furthermore, as shown in FIGS. 23, 24, and 25 which is a cross sectional view taken along line A-A illustrated in FIG. 23 as an example, the metal plate 14E can be inserted into part of the drive package 22P on the +R side in the control board 14B to be parallel to the surface of the control board 14B.

In this case, four radiation fins 14D of which one ends are in contact with the metal plate 14E can be provided around the drive package 22P.

Moreover, in this case, as shown in FIG. 26, the radiation fan 22X that sends the wind blowing in a direction from the side of the light source package 100P to the side of the drive package 22P when viewed in the R direction can be provided.

Furthermore, in the present embodiment, the light source 100 includes 32 light emitting units; however, the number of the light emitting units of the light source 100 is not limited thereto.

Moreover, in the present embodiment, the laser printer 1000 is explained as the image forming apparatus; however, it is not limited thereto and any image forming apparatus including the optical scanning device 1010 can be employed.

For example, the image forming apparatus can be employed, which includes the optical scanning device 1010 and directly irradiates a medium, such as a sheet of paper, which is developed by a laser beam, with a laser beam.

Furthermore, the image forming apparatus can be configured to use a silver halide film as an image carrier. In this case, a latent image is formed on a silver halide film by optical scanning, which can be developed by a process equivalent to a developing process in a typical silver halide photographic process. The developed latent image can be transferred onto a printing paper by a process equivalent to a printing process in the typical silver halide photographic process. Such image forming apparatus can be applied to an optical plate making apparatus or an optical drawing apparatus that draws a computed tomography (CT) scan image.

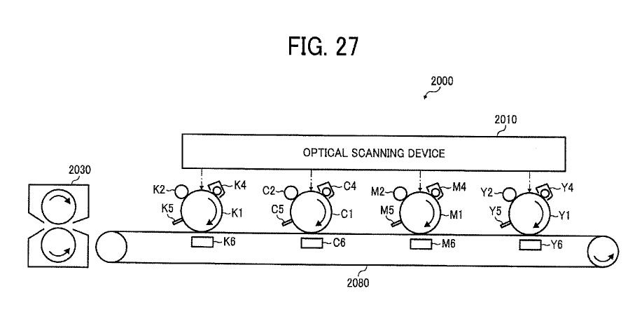

Moreover, as shown in FIG. 27 as an example, the image forming apparatus can be a color printer 2000 including a plurality of photosensitive elements.

The color printer 2000 is a tandem-type multi-color printer that forms a full color image by superimposing four color (black (K), cyan (C), magenta (M), and yellow (Y)) images. The color printer 2000 includes photosensitive elements K1, C1, M1, and Y1, charging units K2, C2, M2, and Y2, developing units K4, C4, M4, and Y4, cleaning units K5, C5, M5, Y5, and transferring units K6, C6, M6, and Y6, for the four colors. The color printer 2000 further includes an optical scanning device 2010, a transferring belt 2080, and a fixing unit 2030.

Each photosensitive element rotates in a direction indicated by an arrow in FIG. 27. The charging unit, the developing unit, the transferring unit, and the cleaning unit are arranged around each photosensitive element in this order in a direction in which the photosensitive element rotates. Each charging unit uniformly charges the surface of a corresponding photosensitive element. The optical scanning device 2010 irradiates the surface of each photosensitive element charged by the corresponding charging unit with a light beam, so that a latent image is formed on each photosensitive element. Then, each latent image is developed into a toner image by a corresponding developing unit. Each toner image is transferred onto a recording sheet by a corresponding transferring unit. Finally, the toner images transferred onto the recording sheet is fixed thereto by the fixing unit 2030.

The optical scanning device 2010 includes a light source device similar to the light source device 14, a pre-deflector optical system similar to the above descried one, and a scanning optical system similar to the above descried one for each color.

A light beam emitted from each light source device is deflected by a common polygon mirror through the corresponding pre-deflector optical system, and irradiated to the corresponding photosensitive element through the corresponding scanning optical system.

According, the optical scanning device 2010 can have an effect similar to the optical scanning device 1010. Thus, the color printer 2000 can have an effect similar to the laser printer 1000.

The color printer 2000 can include the optical scanning device for each one or two colors.

According to one aspect of the present invention, a light source device can suppress temperature increase of light source units accommodated therein without enlarging size and cost thereof.

According to another aspect of the present invention, an optical scanning device, having the light source device in the present invention therein, can stably scan without enlarging size and cost thereof.

According to still another aspect of the present invention, an image forming apparatus, having the optical scanning device in the present invention therein, can form image with high speed and good quality without enlarging size and cost thereof.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A light source device comprising:
a light source that includes a plurality of light emitting units;
a drive circuit that drives the light source; and
a circuit board on which the light source is mounted in a first area and the drive circuit is mounted in a second area and which includes a radiation mechanism between the first area and the second area for heat from the drive circuit.

2. The light source device according to claim 1, wherein
the light source is mounted on one surface of the circuit board,
the drive circuit is mounted on another surface of the circuit board, and
the radiation mechanism includes a metal layer that is inserted into the circuit board to be parallel to the surface of the circuit board.

3. The light source device according to claim 2, wherein the metal layer is provided in part of the circuit board corresponding to the second area.

4. The light source device according to claim 2, wherein the radiation mechanism includes at least one radiation fin provided so that part of the radiation fin is in contact with the metal layer.

5. The light source device according to claim 4, wherein
the radiation fin is a plurality of radiation fins, and
the radiation fins are arranged around the second area.

6. The light source device according to claim 4, wherein the radiation mechanism includes a radiation fan that sends a wind blowing in a direction from a side of the light source to a side of the drive circuit to the radiation fin when viewed from a thickness direction of the circuit board.

7. The light source device according to claim 1, wherein the light source and the drive circuit are arranged not to overlap with each other when viewed from a thickness direction of the circuit board.

8. The light source device according to claim 1, wherein
the light source and the drive circuit are arranged on one surface of the circuit board, and
the radiation mechanism includes a radiation fin arranged between the first area and the second area.

9. The light source device according to claim 8, wherein
the radiation fin has a shape in which a first side in one direction is longer than a second side in another direction, and
the first side is orthogonal to a virtual line connecting a center of the first area and a center of the second area.

10. The light source device according to claim 8, wherein
the radiation mechanism includes a plurality of radiation fins, and
the radiation fins are arranged around the second area.

11. The light source device according to claim 8, wherein the radiation mechanism includes a radiation fan that sends a wind blowing in a direction from a side of the light source to a side of the drive circuit.

12. The light source device according to claim 7, wherein
the light source and the drive circuit are accommodated in a square-shaped first package and a square-shaped second package, respectively, and
the first package is arranged to be divided approximately into two by a virtual line extending a diagonal line that passes a corner portion of the second package.

13. The light source device according to claim 8, wherein
the light source and the drive circuit are accommodated in a square-shaped first package and a square-shaped second package, respectively, and
the first package is arranged to be divided approximately into two by a virtual line extending a diagonal line that passes a corner portion of the second package.

14. The light source device according to claim 1, wherein the light source is a vertical cavity surface emitting laser array.

15. An optical scanning device that scans a scanning surface with a light beam, the optical scanning device comprising:
a light source device including
a light source that includes a plurality of light emitting units,
a drive circuit that drives the light source, and
a circuit board on which the light source is mounted in a first area and the drive circuit is mounted in a second area and which includes a radiation mechanism between the first area and the second area for heat from the drive circuit,
a deflector that deflects the light beam output from the light source device; and
a scanning optical system that focuses the light beam deflected by the deflector on the scanning surface.

16. An image forming apparatus comprising:
at least one image carrier; and
at least one optical scanning device that scans the image carrier with a light beam containing image information and that includes
a light source device including
a light source that includes a plurality of light emitting units,
a drive circuit that drives the light source, and
a circuit board on which the light source is mounted in a first area and the drive circuit is mounted in a second area and which includes a radiation mechanism between the first area and the second area for heat from the drive circuit,
a deflector that deflects the light beam output from the light source device, and
a scanning optical system that focuses the light beam deflected by the deflector on the scanning surface.

17. The image forming apparatus according to claim 16, wherein the image information is multicolor image information.
